(19) United States
(12) Patent Application Publication
(10) Pub. No.: US 2017/0283137 A1
(43) Pub. Date: Oct. 5, 2017

(54) PORTABLE WATER PURIFYING BOTTLE

(71) Applicant: Xiamen Runner Industrial Corporation, Xiamen (CN)

(72) Inventors: JOEY JIANG, Xiamen (CN); DENNIS SHEN, Xiamen (CN); INSCY ZHOU, Xiamen (CN); JIN-FA WANG, Xiamen (CN)

(21) Appl. No.: 15/473,770

(22) Filed: Mar. 30, 2017

(30) Foreign Application Priority Data
Mar. 30, 2016 (CN) 201610188026.2

(51) Int. Cl. B65D 51/16; B01D 29/11; A45F 3/16; B65D 51/24; B65D 53/02; C02F 1/00; B65D 1/02

(52) U.S. Cl. CPC B65D 51/1616; C02F 1/003; B01D 29/114; B65D 1/02; B65D 51/245; B65D 53/02; A45F 3/16; C02F 2307/02; A45F 2003/163

(57) ABSTRACT

A portable water purifying bottle comprises: an upper cover, having a water output port; a filter core component, disposed inside the upper cover, and located below the water output port; and a plastic cup sleeve, sleeved into a lower portion of the upper cover. The portable water purifying bottle is simple in design, the plastic cup sleeve made of silicone for storing water is retractable for easy carrying, thus fulfilling the needs of outdoor user. Further, the portable water purifying bottle is able to provide water output at fast speed to save time, while its appearance is compact and pleasing, hereby having a good prospect in the market.

### BACKGROUND OF THE INVENTION

### Field of the Invention

The present invention relates to a water purifying bottle, and in particular to a portable water purifying bottle.

### The Prior Arts

In general, water purifying bottle has the problem of occupying too much space, and it is not convenient to carry, hereby causing quite inconvenience to the sports loving people and outdoor survival explorer.

Therefore, presently, the design and performance of the water purifying bottle is not quite satisfactory, and it leaves much room for improvement.

### SUMMARY OF THE INVENTION

In view of the problems and drawbacks of the prior art, the present invention provides a portable water purifying bottle.

The present invention provides a portable water purifying bottle, that includes: an upper cover, a filter core component, and a plastic cup sleeve. The upper cover is provided with a water output port. The filter core component is disposed inside the upper cover, and is located below the water output port; while the plastic cup sleeve is sleeved into a lower portion of the upper cover.

In an aspect of the present invention, the filter core component includes: an upper end cover, rotatably connected to a lower portion of the water output port; a lower end cover; a filter core outer shell, disposed between the upper end cover and the lower end cover; and a filter core, disposed inside the filter core outer shell.

In another aspect of the present invention, the portable water purifying bottle further includes: a water passage hole, disposed on the upper end cover, to connect the water output port and an inner chamber of the filter core; and a plurality of water input mesh holes, disposed around a surrounding wall of the filter core outer shell.

In yet another aspect of the present invention, the upper cover includes a fixing sleeve, rotatably connected to a lower end of the upper cover, while the plastic cup sleeve is sleeved around the lower portion of the fixing sleeve.

In a further aspect of the present invention, inside an opening of the plastic cup sleeve is provided with a protrusion ring protruding inward; on an outer surrounding portion at a lower end of the fixing sleeve is provided with a ring shape slot acting in cooperation with the protrusion ring; and around the fixing sleeve is disposed a decoration ring pressing tightly against the opening of the plastic cup sleeve.

In another aspect of the present invention, the portable water purifying bottle further includes: a bottle cover, fastened onto the water output port, to act in rotatable cooperation with the water output port; a decoration cover, fastened onto the bottle cover; a pull ring, disposed above the bottle cover, and penetrating out through a hole in a center of the decoration cover; and a block plate, connected and fixed to a lower end of the pull ring, to fasten to a lower side of the decoration cover.

The portable water purifying bottle of the present invention can be implemented through the following steps: in a water filling step, rotate the decoration ring, to remove the decoration ring, the fixing sleeve, and the plastic cup sleeve at the same time, next, pour water into the plastic cup sleeve, and then put the decoration ring, the fixing sleeve, and the plastic cup sleeve onto the upper cover at the same time; in a water drinking step, rotate the decoration cover, to remove the decoration cover, the bottle cover, and the pull ring at the same time, then, squeeze the plastic cup sleeve, so that water is made to flow out from the water output port for drinking; and when the portable water purifying bottle is empty, or little water remains therein, the plastic cup sleeve can be retracted to be stored in the fixing sleeve.

Compared with the existing technology, the present invention has the advantages in that, the portable water purifying bottle is simple in design, the plastic cup sleeve made of silicone for storing water is retractable for easy carrying, thus fulfilling the needs of outdoor user. Further, it is able to provide water output at fast speed to save time, while its appearance is compact and pleasing, as such having a good prospect in the market.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a portable water purifying bottle according to an embodiment of the present invention;

FIG. 2 is an exploded view of a portable water purifying bottle according to an embodiment of the present invention;

FIG. 3 is a cross section view of a portable water purifying bottle according to an embodiment of the present invention;

FIG. 4 is a cross section view of a portable water purifying bottle having its plastic cup sleeve retracted according to an embodiment of the present invention; and

FIG. 5 is another exploded view of a portable water purifying bottle according to an embodiment of the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

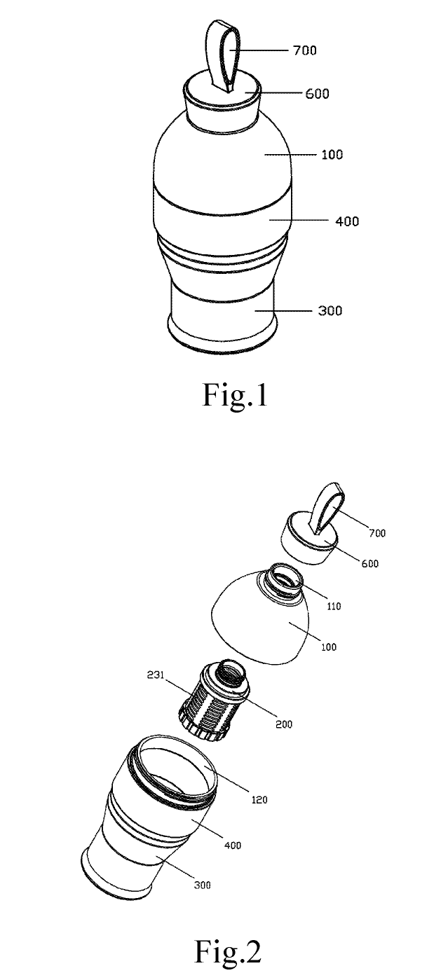

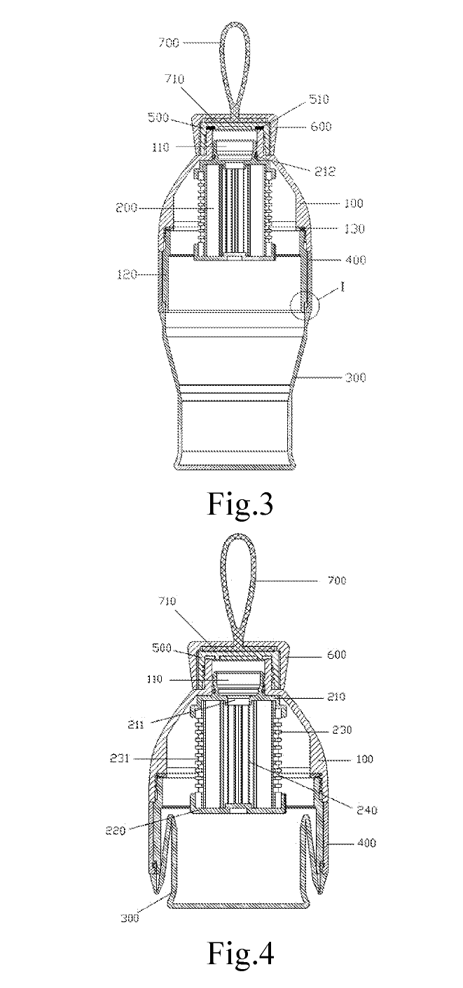

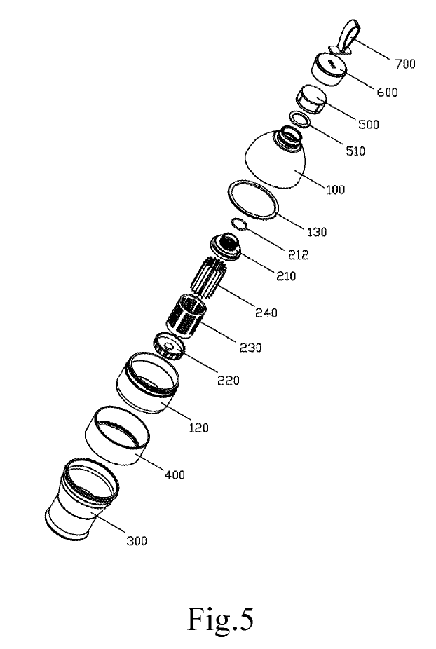

Refer to FIGS. 1 to 5 respectively for a schematic diagram of a portable water purifying bottle according to an embodiment of the present invention; an exploded view of a portable water purifying bottle according to an embodiment of the present invention; a cross section view of a portable water purifying bottle according to an embodiment of the present invention; a cross section view of a portable water purifying bottle having its plastic cup sleeve retracted according to an embodiment of the present invention; and another exploded view of a portable water purifying bottle according to an embodiment of the present invention.

As shown in FIGS. 1 to 5, the present invention provides a portable water purifying bottle, that includes: an upper cover 100, a filter core component 200, and a plastic cup sleeve 300. The upper cover 100 is provided with a water output port 110. The filter core component 200 is disposed inside the upper cover 100, and is located below the water output port 110; while the plastic cup sleeve 300 is sleeved into a lower portion of the upper cover 100. In the present invention, water is stored in the plastic cup sleeve 300. When a user desires to drink water, the portable water purifying bottle is put upside down, then squeeze the plastic cup sleeve 300, such that water flows through and is filtered by the filter core component 200 to flow out from the water output port. By squeezing the plastic cup sleeve 300, the water pressure in the portable water purifying bottle is raised, to expedite water output.

In an embodiment of the present invention, the filter core component 200 includes: an upper end cover 210, rotatably connected to a lower portion of the water output port 110; a lower end cover 220; a filter core outer shell 230, disposed between the upper end cover 210 and the lower end cover 220; and a filter core 240, disposed inside the filter core outer shell 230.

In an embodiment of the present invention, the portable bottle further includes: a water passage hole 211, disposed on the upper end cover 210, to connect to the water output port 110 and an inner chamber of the filter core 240; and a plurality of water input mesh holes 231, disposed around a surrounding wall of the filter core outer shell 230. The filter core 240 is of a barrel shape, water flows through the water input mesh holes 231 on the filter core outer shell 230 into the inner chamber of the filter core outer shell 230, to reach the perimeter of the filter core 240. Then, water is filtered through the filter core 240 and it enters into its inner chamber. The filtering material of the filter core 240 is certified by NSF (National Sanitation Foundation), and it can not only filter out bacterial, virus, and other contaminants, but it may also provide good taste, in achieving excellent filtering effect. Moreover, the filter core 240 can be replaced readily, so that user may select different filter cores 240 depending on the quality of water, to ensure safe drinking.

In an embodiment of the present invention, the upper cover 100 includes a fixing sleeve 120, rotatably connected to a lower end of the upper cover 100, while the plastic cup sleeve 300 is sleeved around the lower portion of the fixing sleeve 120. When adding water, all it has to do is to rotate and take off the fixing sleeve 120, then pour water into the plastic cup sleeve 300.

In an embodiment of the present invention, inside an opening of the plastic cup sleeve 300 is provided with a protrusion ring 310 protruding inward; on an outer surrounding portion at a lower end of the fixing sleeve 120 is provided with a ring shape slot 121 acting in cooperation with the protrusion ring 310; and around the fixing sleeve 120 is disposed a decoration ring 400 pressing tightly against the opening of the plastic cup sleeve 300, so that when rotating the decoration ring 400. the fixing sleeve 120 is rotated synchronously.

In an embodiment of the present invention, the portable water purifying bottle further includes: a bottle cover 500, fastened onto the water output port 110, to act in rotatable cooperation with the water output port 110; a decoration cover 600, fastened onto the bottle cover 500, so that when rotating the decoration cover 600, the bottle cover 500 is rotated synchronously; a pull ring 700, disposed above the bottle cover 500, and penetrating out through a hole in a center of the decoration cover 600; and a block plate 710, connected and fixed to a lower end of the pull ring 700, to fasten to a lower side of the decoration cover 600. The pull ring 700 is made of silicone, it can be put on a bag, or sleeved around the finger, for carrying it conveniently.

In an embodiment of the present invention, in order to ensure overall tight seal of the portable water purifying bottle, in the upper cover 100 is provided with a first washer 130 pressing against the upper end surface of the fixing sleeve 120; on the top portion of the bottle cover 500 is provided with a second washer 510 pressing against the upper end surface of the water output port 110. The upper end cover 210 and the protrusion mouth portion acting in rotation cooperation with the water output port, are sleeved around with tight seal rings respectively.

In an embodiment of the present invention, the outer surfaces of the decoration cover 600, the upper cover 100, and the decoration ring 400 are processed by the slip resistance paint, to increase their friction, for the convenient handling by the hand, and in conformity with the design of ergonomics. The plastic cup sleeve 300 is made of semi-transparent silicone. That is a kind of high strength silicone, solid and endurable, so that the plastic cup sleeve 300 can be retracted into the portable water purifying bottle to facilitate easy carrying.

The portable water purifying bottle of the present invention can be implemented through the following steps: in a water filling step, rotate the decoration ring 400, to remove the decoration ring 400, the fixing sleeve 120, and the plastic cup sleeve 300 at the same time, next, pour in water into the plastic cup sleeve 300, and then put the decoration ring 400, the fixing sleeve 120, and the plastic cup sleeve 300 onto the upper cover 100 at the same time; in a water drinking step, rotate the decoration cover 600, to remove the decoration cover 600, the bottle cover 500, and the pull ring 700 at the same time, then, squeeze the plastic cup sleeve 300, so that water is made to flow out from the water output port for drinking; and when the portable water purifying bottle is empty, or little water remains therein, the plastic cup sleeve 300 can be retracted to be stored in the fixing sleeve 120.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A portable water purifying bottle, comprising:
an upper cover, having a water output port;
a filter core component, disposed inside the upper cover, and located below the water output port; and
a plastic cup sleeve, sleeved into a lower portion of the upper cover.

2. The portable water purifying bottle as claimed in claim 1, wherein the filter core component includes:
an upper end cover, rotatably connected to a lower portion of the water output port;
a lower end cover;
a filter core outer shell, disposed between the upper end cover and the lower end cover; and
a filter core, disposed inside the filter core outer shell.

3. The portable water purifying bottle as claimed in claim 2, further comprising:
a water passage hole, disposed on the upper end cover, to connect the water output port and an inner chamber of the filter core; and
a plurality of water input mesh holes, disposed around a surrounding wall of the filter core outer shell.

4. The portable water purifying bottle as claimed in claim 3, wherein the upper cover includes a fixing sleeve, rotatably connected to a lower end of the upper cover, while the plastic cup sleeve is sleeved around a lower portion of the fixing sleeve.

5. The portable water purifying bottle as claimed in claim 4, wherein inside an opening of the plastic cup sleeve is provided with a protrusion ring protruding inward; on an outer surrounding portion at a lower end of the fixing sleeve is provided with a ring shape slot acting in cooperation with the protrusion ring; and around the fixing sleeve is disposed a decoration ring pressing tightly against the opening of the plastic cup sleeve.

6. The portable water purifying bottle as claimed in claim 5, further comprising:
a bottle cover, fastened onto the water output port, to act in rotatable cooperation with the water output port;
a decoration cover, fastened onto the bottle cover;
a pull ring, disposed above the bottle cover, and penetrating out through a hole in a center of the decoration cover; and
a block plate, connected and fixed to a lower end of the pull ring, to fasten to a lower side of the decoration cover.

7. The portable water purifying bottle as claimed in claim 6, that is implemented through the following steps:
in a water filling step, rotate the decoration ring, to remove the decoration ring, the fixing sleeve, and the plastic cup sleeve at the same time, next, pour water into the plastic cup sleeve, and then put the decoration ring, the fixing sleeve, and the plastic cup sleeve onto the upper cover at the same time;
in a water drinking step, rotate the decoration cover, to remove the decoration cover, the bottle cover, and the pull ring at the same time, then squeeze the plastic cup sleeve, so that water is made to flow out from the water output port for drinking; and
when the portable water purifying bottle is empty, or little water remains therein, the plastic cup sleeve is retracted to be stored in the fixing sleeve.
